(19) United States
(12) Patent Application Publication
(10) Pub. No.: US 2022/0224048 A1
(43) Pub. Date: Jul. 14, 2022

(54) AUTOMATIC COUPLER ASSEMBLY

(71) Applicant: PRODRIVE TECHNOLOGIES INNOVATION SERVICES B.V., Son en Breugel (NL)

(72) Inventors: Tom Adrianus Henricus VAN DER KANT, Son (NL); Koen Joseph MEESSEN, Son (NL)

(21) Appl. No.: 17/614,281

(22) PCT Filed: May 27, 2020
(86) PCT No.: PCT/EP2020/064765

§ 371 Date: Nov. 24, 2021

(30) Foreign Application Priority Data
May 27, 2019 (EP) 19176839.9
Aug. 23, 2019 (EP) 19193472.8
Oct. 22, 2019 (EP) 19204482.4

(51) Int. Cl. H01R 13/631; B60L 53/16

(52) U.S. Cl. CPC H01R 13/631; B60L 53/35; H01R 2201/26; B60L 53/16

(57) ABSTRACT

A socket of an automatic coupler assembly is arranged for receiving a plug along a first direction. The socket includes a first means for limiting the movement of the plug in the first direction and a second means for blocking the movement of the plug in a second direction opposite to the first direction.

### TECHNICAL FIELD

The present disclosure relates to an automatic coupler assembly. More specifically the present disclosure relates to a socket or a plug for an automatic coupler assembly for charging the battery of an electric vehicle. The present disclosure further relates to a charging station or a vehicle. The present disclosure further relates to a vehicle or a charging station comprising parts of an automatic coupler assembly. The present disclosure further relates to a method for automatically mating parts of an automatic coupler assembly.

### BACKGROUND

Charging of an electric vehicle (EV) such as a plug-in hybrid electric vehicle (PHEV) or a battery electric vehicle (BEV) is typically accomplished by a wired connection between a charging station and the vehicle. To this end, the electric vehicle comprises a socket that can be mated with a plug that is removably attached to the charging station. Nowadays, several types of sockets are readily available. However, the disadvantage of all of these regular sockets is they require manually mating the plug and socket.

Automated coupler systems are known, but they generally require complex positioning systems for mating the plug with the socket that is provided on the vehicle, for instance because it should accommodate mating sockets positioned differently (e.g. location, orientation) on different vehicles and/or vehicles positioned differently.

WO2016119000 discloses a system that requires a less complex positioning system because the socket is located on the underside of the vehicle and comprises vertically oriented concentric connectors. Such a coupler system allows a relatively simple movement of the plug in a vertical direction to mate the plug with the socket of various types of vehicles in a similar way once plug and socket are aligned, because the orientation of the underside of vehicles is normally parallel to the ground, while the concentric connectors provide an axisymmetric design that allows mating the plug and socket in various orientations. The disadvantages of this type of system are that it requires a significant externally applied force for mating plug and socket, and a constant holding force for maintaining a connection. Consequently, a complex compliance mechanism (e.g. suspension) is required for allowing unpredictable car movement during mating or when mated.

### SUMMARY

It is an object of the present disclosure to provide a plug and socket suitable for charging electric vehicles wherein the mating process can be performed in an automated manner, that is simpler, costs less, contains less elements and allows for easier compliance implementation. Preferably, embodiments according to the present disclosure are suitable for charging electric vehicles with an alternating current of at least 10 ampere, for instance single phase power at 13 A, 16 A or 32 A respectively providing about 3 kW, 4 kW or 7 kW of power, or three phase power at 16 A, 32 A, 60 A per phase respectively providing about 11 kW, 22 kW or 43 kW. Alternatively, embodiments according to the present disclosure are preferably suitable for charging electric vehicles with a direct current providing for instance between 50 kW and 350 kW (e.g. 120 kW). Embodiments according to the present disclosure preferably solve one or preferably all of the disadvantages associated with solutions according to the prior art.

According to a first aspect of the present disclosure the object is achieved by providing a socket according to the appended claims. A socket arranged for receiving a plug along a first direction, comprising a first means suitable or configured for limiting the movement of the plug in the first direction and a second means suitable or configured for blocking the movement of the plug in a second direction opposite to the first direction achieves the object of the present disclosure, because for maintaining a connection a complex compliance mechanism to allow movement of the socket and a high holding force exerted on the plug is not required. The first means limit the movement of the plug in a first directions and the second means block the movement of the plug in the second direction opposite to the first direction, thus ensuring that the movement of the plug is restricted such that the connection is maintained, without requiring a complex compliance mechanism and applying an external holding force. Furthermore, a socket according to the present disclosure enables the use of back-drivable drivetrains on the mover or robotic manipulator used for moving the plug, which is beneficial because back driveable axes can allow movement of the socket making the system compliant to movement of the car, without operating the drivetrains after plug and socket are mated.

Advantageously, at least a directional component of the first direction is upward, preferably the first direction is essentially upward. Such a socket arranged for receiving a plug that is moving upward can be attached to the underside of a vehicle. This has the benefit that it is typically essentially parallel to the ground, thereby simplifying mating a plug and socket and allowing for standardization.

Advantageously, the first means is configured for at least in part providing a first alignment of the plug and socket for mating, such as a first translational alignment (e.g. for limiting displacement of the plug relative to the socket) along a first axis of translation substantially parallel to the first direction. Such first means may additionally or alternatively be configured for providing a first rotational alignment (e.g. for rotating the plug relative to the socket) about a first axis of rotation substantially orthogonal to the first direction, and preferably also a second axis of rotation substantially orthogonal to the first axis of rotation and the first direction.

Advantageously, the second means is configured for at least in part providing a second alignment of the plug and socket for mating, such as a second rotational alignment (e.g. for rotating the plug relative to the socket) about a third axis of rotation parallel to the first direction. Such second means may additionally or alternatively be configured for providing a second translational alignment (e.g. for limiting displacement of the plug relative to the socket) along a second axis of translation substantially orthogonal to the first direction and preferably a third axis of translation substantially orthogonal to the second axis of translation and the first direction.

In an advantageous embodiment of a socket according to the present disclosure the first and second means are configured for jointly providing alignment of the plug and socket for mating (e.g. through the first alignment and the second alignment) along three orthogonal translational axes and three orthogonal rotational axes, preferably by rotating the plug relative to the socket about the first, the second and the third axis of rotation and translating the plug relative to the socket along the first, the second and the third axis of translation. The second means may further be configured for mating the plug and the socket, preferably by translating the plug along the second axis of translation.

The first means may be or comprise a physical limiter, which has the benefit that such a first means is robust. The physical limiter for instance provides an abutting surface, which is preferably substantially perpendicular to the first direction and may define a limiter plane extending substantially orthogonally to the first direction. For instance, the limiter plane is a substantially horizontal plane. Such an abutting surface may be configured such that it functions as a means for aligning, for instance by centering and/or orienting, the plug for mating with the socket.

The second means preferably comprises a gripper configured for engaging the plug. Such a gripper comprises two engaging members moveable relative to one another in a third direction having at least a directional component perpendicular to the first direction (e.g. along the second axis of translation). In an advantageous embodiment, at least one of the two engaging members is driven, for instance by a powered actuator such as a linear actuator, for moving the two engaging members relative to one another. In such an embodiment, the gripper can function in a fully automated manner and does not depend on a force applied externally, for instance on the plug. Preferably, at least one of the engaging members is movable relative to the physical limiter, for instance by sliding along the limiter plane. The benefit of such a gripper is that it does not extend along the first direction and therefore allows a low build height along the first direction. This greatly reduces any prejudices for attaching a socket to the underside of the vehicle, where there is limited space and ground clearance.

In an exemplary embodiment according to the present disclosure at least one of the two engaging members comprises at least one electrical connector (e.g. being or comprising an electrical contact). Preferably, the at least one electrical connector is configured to be mated with a contra-connector of the plug when the two engaging members are moved towards one another along the third direction. This has the benefit that the socket provides an integral solution for mating and thus no external force (e.g. by a robot manipulator) needs to be applied for mating a plug with the socket.

Preferably, at least one of the engaging members is arranged for retaining the plug by blocking the movement of the plug in the second direction. Such blocking is preferably achieved other than by friction alone. It may for instance be achieved by providing a blocking element in a path of the plug along the second direction. Such a blocking element may comprise a geometrical feature provided on the at least one engaging member complementary to (e.g. interlocking) a geometrical feature provided on the plug. In a beneficial embodiment, the at least one engaging member arranged for retaining the plug comprises at least one electrical connector. This may ensure that an electrical connection is maintained as long as the plug is retained by the at least one engaging member.

In a beneficial embodiment, the at least one electrical connector is configured to be mated with a contra-connector of the plug when the two engaging members are moved towards one another along the third direction. In such an embodiment, there is a closed force loop in the socket and the mating force does not need to be externally delivered to the plug by for instance a mover or a robot manipulator. An example of a suitable connector for such an embodiment is an elongate electrical connector that extends along the third direction. Such elongate electrical connector may be configured to provide the geometrical feature for retaining the plug by the at least one engaging member, for instance by interlocking the contra-connector provided on the plug. Such a connector preferably is a sliding connector, that is arranged to be slidably mated with a contra-connector, for instance a male or a female connector arranged on the plug. Providing such a socket on the underside of a vehicle, has the benefit that it provides a sliding connection in a direction essentially parallel to the ground and perpendicular to earth's gravitational force acting on the plug. Thereby retaining the plug by blocking movement in the second direction essentially parallel to the earth's gravitational force.

In an embodiment according to the present disclosure, the two engaging members and optionally the physical limiter define a cavity having a first state for receiving the plug, wherein the two engaging members are at a distant location with respect to one another, and a second state for blocking the movement of the plug in the second direction, wherein the two engaging members are at a proximal location with respect to one another, wherein in the distant location the two engaging members are located further apart from one another along the third direction than in the proximal location. Possibly, in the second state the two engaging members are configured for abutting opposing surfaces of the plug. In such an embodiment the various surfaces that are arranged for abutting the plug can work together for aligning (e.g. by means of translating, rotating) the contra-connectors of the plug with the connectors of the socket.

A socket according to the present disclosure preferably comprises alignment features. For instance, a surface of a first one of the two engaging members facing a second one of the two engaging members comprises a first geometry for complementing a second geometry of a reciprocal surface of the plug. Such first and second geometries are preferably arranged for interlocking one another. Examples of complementary or interlocking geometries are a convex, a concave, a tapered, a pawn like, a triangular, a rounded, a circular, a rod-like (in particular a rod) shape and combinations of these. These complementary or interlocking geometries may be configured for blocking the movement of the plug in the second direction.

Preferably, the features for alignment provided by the physical limiter (e.g. an abutting surface) are configured for at least in part aligning the plug and socket for mating. For instance, the physical limiter may be configured to align the plug along the limiter plane. Such alignment may for instance comprise the first translational alignment or the first rotational alignment. Additionally or alternatively, the features for alignment provided by at least one of the two engaging members (e.g. geometrical features configured for being complementary to or interlocking with geometrical features provided on the plug) are configured for providing the second rotational alignment or the second translational alignment.

In a beneficial embodiment, the socket has a closed state, wherein the two engaging members are configured to abut one another along the third direction. Such a configuration allows the engaging members to close the socket and thereby seal off an area (e.g. the cavity) of the socket, configured for receiving the plug, from the external environment when the socket is idle (e.g. not used for mating or charging). Furthermore, such an embodiment may keep the receiving area and other features of the socket clean from pollution, without requiring additional means for sealing the socket when idle, such as a cover potentially driven by additional actuating means. Optionally, the two engaging members are configured to fit into one another along the third direction, for instance by providing complementary shaped surfaces on a side of either engaging member facing the other engaging member. In the closed state of such an embodiment, the two engaging members may be fitted into one another along the third direction. Potentially, the closed state can be reached using the same driving means as being used for driving the engaging members during mating.

According to a second aspect of the present disclosure the object is achieved by providing a plug according to the appended claims. Such a plug achieves the object of the present disclosure in the same way as the socket.

Such a plug may comprise a second surface comprising a first geometry suitable for or configured for complementing (e.g. interlocking) a second geometry of a reciprocal surface of the socket, wherein the first geometry is further configured for aligning the plug and socket for mating. Preferably, the first geometry is configured for providing a second alignment of the plug and socket for mating, wherein the second alignment comprises a second rotational alignment about a third axis of rotation parallel to the first direction and a second translational alignment along a second axis of translation substantially orthogonal to the first direction and optionally a third axis of translation substantially orthogonal to the second axis of translation and the first direction

In an exemplary embodiment of the present disclosure, wherein the first means is a physical limiter, such as an abutting surface, the plug comprises a first surface suitable or configured for abutting the abutting surface of the socket, wherein the first surface is configured for aligning the plug along a first plane, a second surface oriented substantially perpendicular to the first surface, comprising a first geometry suitable or configured for complementing or interlocking a second geometry of a reciprocal surface of the socket configured to aligning the plug and socket for mating, and optionally at least one elongate contra-connector extending along the first plane. In a preferred embodiment, where the elongate contra-connector extends horizontally, the contra-connector is protected from dirt falling in (e.g. a female contra-connector).

Preferably the plug and/or socket comprises at least one electrical connector or contact. The at least one electrical connector advantageously comprises a plurality of electrical connectors or contacts arranged next to one another forming a plane, to minimize the build height of the socket, plug and/or charging station. For example, when these are used for charging electric vehicles a limited build height reduces the impact on the design of the vehicle for incorporating a socket. Furthermore, it eases installation of a charging station, since a low build height allows driving over such charging stations without requiring modifications of the mounting surface.

To this end the plug has an elongate shape. Even more preferably, the elongate shape extends along the first plane, when the plug is aligned along the first plane. Such an elongate shape has the benefit that the socket may also have a lower build height. When such a plug comprises multiple contra-connectors they may beneficially be arranged along the elongated shape. Preferably, the number and type of connectors is similar to regular manual plugs used for charging EV's. Typically, 7 contra-connectors are used providing protective earth, three phases, neutral potential and two data/communication-pins.

According to a third aspect of the present disclosure the object is achieved by providing a charging station according to the appended claims. Such a charging station comprising a plug according to the present disclosure achieves the object of the present disclosure in a similar way as the plug.

Such a charging station may be equipped with a mover to move the plug between a first position more distant from a socket according to the present disclosure than a second position, e.g. from the first position distant from the socket to the second position proximate to the socket towards, preferably at least along a first direction. Beneficially, the first direction is upward. Such a mover may also be arranged for moving the plug in a planar direction having at least a directional component perpendicular to the first direction.

In an exemplary embodiment the mover of a charging station according to the present disclosure comprises a pivoting member (e.g. an arm) and a hinging member comprising a hinge, for instance a joint such as a spherical joint (e.g. a ball joint), wherein the hinging member is arranged for connecting the plug to the pivoting member and configured for providing angular freedom for orienting the plug with the socket.

The joint (e.g. ball joint) may allow an angle of rotation of the plug along all x, y, z axes. The axes may be defined as follows: the x-axis being along the pivoting member, the z-axis being along the first direction and the y-axis being perpendicular to the x-axis and the z-axis. Preferably, the plug has a neutral orientation on the pivoting member, for instance wherein an elongate contra connector extending along the first plane is runs essentially in parallel with the pivoting member. From the neutral orientation the plug and ball joint are arranged such to allow an angle of rotation between −45 degrees and 45 degrees around the x-axis, the y-axis and the z-axis. Preferably, the plug and ball joint are arranged such to allow an angle of rotation around the y-axis between −5 degrees and +30 degrees, an angle of rotation around the x-axis between −5 degrees and 5 degrees and an angle of rotation around the z-axis between −35 degrees and +35 degrees. Providing such degrees of freedom places less demanding requirements on the parking precision of a vehicle equipped with a socket, because it allows a relatively high degree of mismatch in plug and socket orientation.

The charging station may be arranged such that the plug, after being released from the socket, automatically returns to the neutral orientation. For instance, the charging station comprises a resilient member (e.g. a spring between the plug and the pivoting member) for biasing the plug towards the neutral orientation. The ball joint and plug may also be arranged such that the neutral orientation can be fixed, for instance by a snap-lock, such as a ball plunger in one part of the ball joint and a complementary recess in another part of the ball joint. Such a snap-lock may configured to be released by the first surface abutting the abutting surface.

The charging station may further comprise a base having a bottom surface for attaching the station to for instance a ground surface of a parking space. The mover may be a pivoting member attached to the base of the charging station via a ball joint or a hinge. Preferably, the attachment is arranged such that the pivoting member allows an angle of rotation with a plane defined by the bottom surface between 0 and 60 degrees, preferably between 0 and 25 degrees, even more preferably between 0 and 15 degrees. Such a range typically allows sufficient freedom of movement for mating the plug with sockets of various vehicles having different amounts of ground clearance. During mating, the pivoting member typically makes an angle between 5 and 20 degrees, preferably between 7 and 15 degrees. Optionally, the base plate is arranged such that in the first position (e.g. 0 degrees) it orients the plug towards the neutral orientation, which orientation may be fixed by the aforementioned snap-lock.

According to a fourth aspect of the present disclosure the object is achieved by providing a vehicle according to the appended claims. Such a vehicle achieves the object of the present disclosure in the same way as a socket according to the present disclosure.

Preferably, the vehicle comprises a socket arranged on the underside of the vehicle. This has the benefit that it is typically arranged essentially parallel to the ground, thereby simplifying mating a plug and socket and allowing for standardization.

According to a fifth aspect of the present disclosure the object is achieved by providing a method according to the appended claims. Such a method for mating a plug and a socket achieves the object in the same way as the socket and the plug and comprises the steps of: moving a plug at least in a first direction towards the socket, limiting the movement of the plug in the first direction to a predetermined halting position, blocking the movement of the plug in a second direction opposite to the first direction upon reaching the predetermined halting position through engaging the plug by the socket. Preferably, at least a directional component of the first direction is upward.

Advantageously, the method comprises a step of aligning the plug along a plane substantially perpendicular to the first direction. This step may be incorporated in the step of limiting the movement of the plug in the first direction.

In a preferred embodiment, engaging the plug comprises clamping the plug between two engaging members of the socket. Advantageously, clamping the plug induces a movement of the plug along the plane thereby mating parts of the plug and the socket. Advantageously, in the step of engaging the plug, clamping the plug is preceded by aligning the plug. For instance, movement of the plug induced by engaging the plug may for example first align mating parts of the plug with mating parts of the socket, followed by mating part of the plug and the socket, which mating may establish an electrical connection between the plug and the socket.

Aspects of the present disclosure as described herein are set out in the following numbered primary clauses:
1. Socket (10) of an automatic coupler assembly arranged for receiving a plug (20) along a first direction, comprising a first means (13) for limiting the movement of the plug in the first direction and a second means (11, 14) for blocking the movement of the plug in a second direction opposite to the first direction.
2. Socket according to primary clause 1, wherein the first direction is upward.
3. Socket according to primary clause 1 or 2, wherein the first means (13) is a physical limiter, such as an abutting surface, preferably the first direction is perpendicular to the abutting surface.
4. Socket according to any one of the preceding primary clauses, wherein the second means comprises a gripper configured for engaging the plug, comprising two engaging members (11, 14) moveable relative to one another in a third direction perpendicular to the first direction, preferably wherein at least one of the engaging members is movable relative to the physical limiter.
5. Socket according to primary clause 4, wherein at least one of the two engaging members comprises at least one electrical connector.
6. Socket according to primary clause 5, wherein the at least one electrical connector is configured to be mated with a contra-connector (21) of the plug when the two engaging members are moved towards one another.
7. Socket according to any one of primary clauses 4 to 6, wherein at least one of the two engaging members is arranged for retaining the plug.
8. Socket according to primary clause 7, wherein the at least one engaging member arranged for retaining the plug comprises the at least one electrical connector.
9. Socket according to primary clause 8 or 9, wherein the at least one electrical connector is an elongate electrical connector extending along the third direction.
10. Socket according to any one of primary clauses 4 to 9, wherein the two engaging members and optionally the physical limiter define a cavity having a first state for receiving the plug, wherein the two engaging members are at a distant location with respect to one another, and a second state for blocking the movement of the plug in the second direction, wherein the two engaging members are at a proximal location with respect to one another.
11. Socket according to primary clause 10, wherein in the second state the two engaging members are configured for abutting opposing surfaces of the plug.
12. Socket according to any one of primary clauses 4 to 11, wherein a surface of a first one of the two engaging members facing a second one of the two engaging members comprises a first geometry for complementing a second geometry of a reciprocal surface of the plug.
13. Socket according to primary clause 12, wherein the first geometry comprises at least one of a protuberance and a depression towards the second one of the two engaging members for aligning the plug.
14. Socket according to primary clause 12 or 13, wherein the first geometry is at least one of a convex, concave, tapered, pawn and triangular shape.
15. Plug (20) of an automatic coupler assembly for co-operation with the socket of any of the preceding primary clauses.
16. Plug according to primary clause 15, comprising a first surface for abutting the abutting surface of the socket according to primary clause 3 and any primary clause dependent thereon wherein the first surface is configured for aligning the plug along a first plane, a second surface oriented substantially perpendicular to the first surface, comprising a first geometry for complementing a second geometry of a reciprocal surface of the socket configured to align the plug and socket for mating, and optionally at least one elongate contra-connector extending along the first plane.
17. Charging station comprising a plug of primary clauses 15 or 16.
18. Charging station according to primary clause 17, further comprising a mover and a ball joint, wherein the ball joint is arranged for connecting the plug to the mover, wherein the mover is configured to move the plug a first position distant from the socket to a second position proximate to the socket.
19. Charging station according to primary clause 18, wherein the second position is elevated with respect to the first position.
20. Vehicle comprising a socket of any one of the primary clauses 1 to 14.
21. Vehicle according to primary clause 20, wherein the socket is arranged on the underside of the vehicle.
22. Method for mating a plug and a socket, comprising the steps of:
   Moving a plug at least in a first direction towards the socket
   Limiting the movement of the plug in the first direction to a predetermined halting position
   Blocking the movement of the plug in a second direction opposite to the first direction upon reaching the predetermined halting position through engaging the plug by the socket.
23. Method according to primary clause 22, wherein the first direction is upward.
24. Method according to primary clause 22 or 23, comprising the step of aligning the plug along a plane substantially perpendicular to the first direction.
25. Method according to any one of primary clauses 22 to 24, wherein engaging the plug comprises clamping the plug between two engaging members of the socket.
26. Method according to primary clause 25, wherein the clamping induces a movement of the plug along the plane thereby mating parts of the plug and the socket.
27. Method according to primary clause 26, wherein the induced movement of the plug aligns mating parts of the plug with mating parts of the socket.
28. Method according to primary clause 26 or 27, wherein the induced movement establishes an electrical connection between the plug and the socket.

Aspects of the present disclosure as described herein are set out in the following numbered secondary clauses:
1. Socket (10) of or for an automatic coupler assembly in particular for charging electric vehicles arranged for receiving a plug (20) along a first direction, comprising a first means (13) for limiting the movement of the plug in the first direction and a second means (11, 14) for blocking the movement of the plug in a second direction opposite to the first direction.
2. Socket according to secondary clause 1, wherein at least a directional component of the first direction is upward, preferably the first direction is essentially upward.
3. Socket according to secondary clause 1 or 2, wherein the first means (13) is a physical limiter, such as an abutting surface, preferably the first direction is perpendicular to the abutting surface.
4. Socket according to any one of the preceding secondary clauses, wherein the second means comprises a gripper configured for engaging the plug, comprising two engaging members (11, 14) moveable relative to one another in a third direction having at least a directional component perpendicular to the first direction, preferably wherein at least one of the engaging members is movable relative to the physical limiter.
5. Socket according to secondary clause 4, wherein at least one of the two engaging members comprises at least one electrical connector, preferably the at least one electrical connector is configured to be mated with a contra-connector (21) of the plug when the two engaging members are moved towards one another along the third direction.
6. Socket according to any one of secondary clauses 4 to 5, wherein at least one of the two engaging members is arranged for retaining the plug by blocking the movement of the plug in the second direction, preferably the at least one engaging member arranged for retaining the plug comprises the at least one electrical connector.
7. Socket according to secondary clause 6, wherein the at least one electrical connector is an elongate electrical connector extending along the third direction.
8. Socket according to any one of secondary clauses 4 to 7, wherein the two engaging members and optionally the physical limiter define a cavity (16) having a first state for receiving the plug, wherein the two engaging members are at a distant location with respect to one another, and a second state for blocking the movement of the plug in the second direction, wherein the two engaging members are at a proximal location with respect to one another.
9. Socket according to secondary clause 8, wherein in the second state the two engaging members are configured for abutting opposing surfaces of the plug.
10. Socket according to any one of secondary clauses 4 to 9, wherein a surface (15) of a first one of the two engaging members facing a second one of the two engaging members comprises a first geometry for complementing a second geometry of a reciprocal surface (24) of the plug.
11. Plug (20) for an automatic coupler assembly for co-operation with the socket of any of the preceding secondary clauses, comprising a first surface (23) for abutting the abutting surface of the socket according to secondary clause 3 and any secondary clause dependent thereon wherein the first surface is configured for aligning the plug along a first plane, a second surface (24) oriented substantially perpendicular to the first surface, comprising a first geometry for complementing a second geometry of a reciprocal surface (15) of the socket configured to align the plug and socket for mating, and optionally at least one elongate contra-connector (21, 25) extending along the first plane.
12. Charging station comprising a plug of secondary clause 11, a mover (30) and a hinging member such as a ball joint (31), wherein the is arranged for connecting the plug (20) to the mover, wherein the mover is configured to move the plug between a first position more distant from the socket (10) than a second position.
13. Vehicle comprising a socket of any one of the secondary clauses 1 to 10, wherein the socket (10) is arranged on the underside of the vehicle.
14. Method for mating a plug (20) and a socket (10), comprising the steps of:
   Moving a plug at least in a first direction towards the socket
   Limiting the movement of the plug in the first direction to a predetermined halting position
   Blocking the movement of the plug in a second direction opposite to the first direction upon reaching the predetermined halting position through engaging the plug by the socket.
15. Method according to secondary clause 14, wherein engaging the plug comprises clamping the plug between two engaging members (11, 14) of the socket, wherein the clamping induces a movement of the plug along the plane thereby mating parts of the plug and the socket, and wherein the induced movement of the plug aligns mating parts of the plug with mating parts of the socket and establishes an electrical connection between the plug and the socket.

Aspects of the present disclosure as described herein are set out in the following numbered tertiary clauses:
1. Socket (10) for an automatic coupler assembly in particular for charging electric vehicles, arranged for receiving a plug (20) along a first direction, comprising a first means (13) for limiting the movement of the plug in the first direction and a second means (11, 14) for blocking the movement of the plug in a second direction opposite to the first direction.
2. Socket according to tertiary clause 1, wherein at least a directional component of the first direction is upward, preferably the first direction is essentially upward.
3. Socket according to tertiary clause 1 or 2, wherein the first means (13) is a physical limiter (16), such as an abutting surface, preferably the first direction is perpendicular to the abutting surface.
4. Socket according to any one of the preceding tertiary clauses, wherein the second means comprises a gripper configured for engaging the plug, comprising two engaging members (11, 14) moveable relative to one another in a third direction having at least a directional component perpendicular to the first direction, preferably wherein at least one of the engaging members is movable relative to the physical limiter.
5. Socket according to tertiary clause 4, wherein at least one of the two engaging members comprises at least one electrical connector, preferably the at least one electrical connector is configured to be mated with a contra-connector (21) of the plug when the two engaging members are moved towards one another along the third direction.
6. Socket according to any one of tertiary clauses 4 to 5, wherein at least one of the two engaging members is arranged for retaining the plug by blocking the movement of the plug in the second direction, preferably the at least one engaging member arranged for retaining the plug comprises the at least one electrical connector.
7. Socket according to tertiary clause 6, wherein the at least one electrical connector is an elongate electrical connector extending along the third direction.
8. Socket according to any one of tertiary clauses 4 to 7, having a first state wherein the two engaging members and optionally the physical limiter (16) define a cavity (17) for receiving the plug, wherein the two engaging members are at a distant location with respect to one another, and a second state for blocking the movement of the plug in the second direction, wherein the two engaging members are at a proximal location with respect to one another.
9. Socket according to tertiary clause 8, wherein in the second state the two engaging members are configured for abutting opposing surfaces of the plug.
10. Socket according to any one of tertiary clauses 4 to 9, wherein a surface (15) of a first one of the two engaging members facing a second one of the two engaging members comprises a first geometry for complementing a second geometry of a reciprocal surface (24) of the plug.
11. Socket according to any one of tertiary clauses 4 to 10, wherein the two engaging members are configured to fit into one another along the third direction.
12. Socket according to any one of tertiary clauses 4 to 11, having a closed state, wherein the two engaging members are configured to abut one another along the third direction and optionally are fitted into one another.
13. Socket according to tertiary clause 12, wherein an outer surface of either of the two engaging members are arranged for jointly forming a continuous outer surface in the closed state.
14. Socket according to any one of the tertiary clauses 4 to 13, wherein the gripper further comprises an ejecting means configured for ejecting the plug from the socket.
15. Socket according to tertiary clause 14 in conjunction with tertiary clause 5, wherein the ejecting means are configured for ejecting the plug along the third direction, preferably the at least one engaging means comprises the ejecting means.
16. Plug (20) for an automatic coupler assembly for co-operation with the socket of any of the preceding tertiary clauses, comprising a second surface (24) comprising a first geometry for complementing a second geometry of a reciprocal surface (15) of the socket configured to align the plug and socket for mating.
17. Plug (20) according to tertiary clause 16, comprising a first surface (23) for abutting the abutting surface of the socket according to tertiary clause 3 and any tertiary clause dependent thereon, wherein the first surface is configured for aligning the plug along a first plane, wherein the first surface (24) is oriented substantially perpendicular to the second surface (24), and optionally the first plug comprising at least one elongate contra-connector (21, 25) extending along the first plane.
18. Charging station comprising a plug of tertiary clause 16 or 17, a mover (30) and a hinging member such as a ball joint (31), wherein the hinging member is arranged for connecting the plug (20) to the mover and offering rotational freedom for aligning the plug along the first direction, wherein the mover is configured to move the plug between a first position more distant from the socket (10) than a second position.
19. Vehicle comprising a socket of any one of the tertiary clauses 1 to 15, wherein the socket (10) is arranged on the underside of the vehicle.
20. Method for mating a plug (20) and a socket (10), comprising the steps of:
   Moving a plug at least in a first direction towards the socket
   Limiting the movement of the plug in the first direction to a predetermined halting position by first means of the socket
   Blocking the movement of the plug in a second direction opposite to the first direction upon reaching the predetermined halting position by second means of the socket.
21. Method according to tertiary clause 20, wherein blocking the plug comprises clamping the plug between two engaging members (11, 14) of the socket, wherein the clamping induces a movement of the plug along the plane thereby mating parts of the plug and the socket, and wherein the induced movement of the plug aligns mating parts of the plug with mating parts of the socket and establishes an electrical connection between the plug and the socket.

### BRIEF DESCRIPTION OF THE DRAWINGS

FIG. 1 shows a side view of a socket and a plug according to an embodiment of the present disclosure.

FIG. 2A, 2B, 2C, 2D shows steps of a method for mating a socket and plug according to an embodiment of the present disclosure in consecutive order.

FIG. 3A shows an exploded view of a vertical mover of a charging station according to an embodiment of the present disclosure equipped with a ball joint for connecting a plug to the vertical mover.

FIG. 3B shows a side view of the vertical mover of FIG. 3A.

FIG. 4A shows a schematic bottom view of a socket according to an embodiment of the present disclosure in a closed state.

FIG. 4B shows a schematic bottom view of the socket of FIG. 4A in a first (open) state and a plug according to an embodiment of the present disclosure positioned in a cavity of the socket.

FIG. 4C shows a schematic bottom view of the socket of FIG. 4A in a second (blocking) state with the plug of FIG. 4B electrically coupled to the socket.

FIG. 5A shows a schematic perspective view of the socket of FIG. 4A in the closed state.

FIG. 5B shows a schematic perspective view of the socket of FIG. 4B in the first (open) state and the plug positioned in the cavity of the socket.

FIG. 5C shows a schematic perspective view of the socket of FIG. 4C in the second (blocking) state wherein the plug is electrically coupled to the socket.

### DETAILED DESCRIPTION

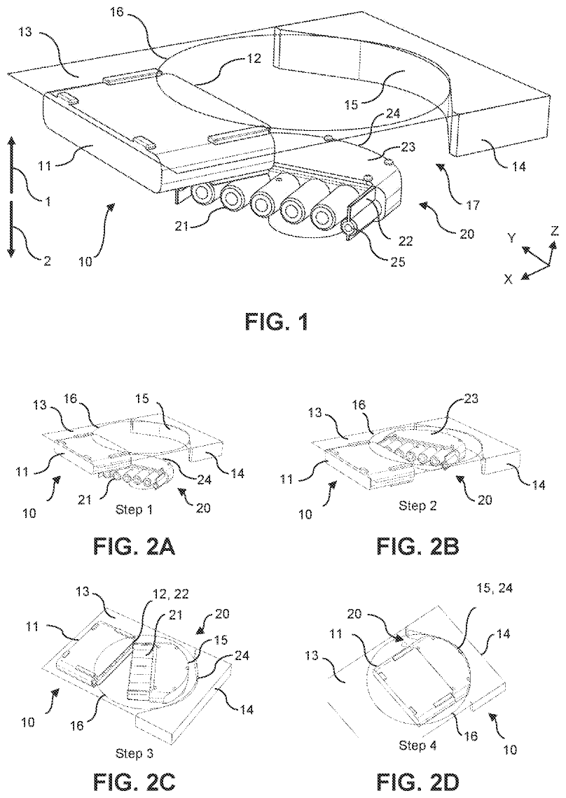

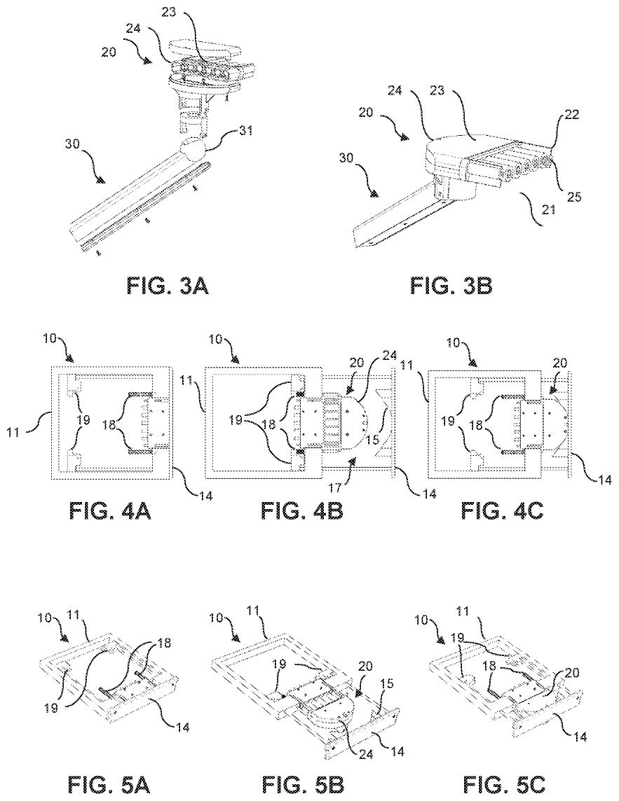

Referring to FIG. 1 and FIG. 3, the present disclosure is related to an automatic coupler assembly such as a vehicle coupler for charging electric vehicles, comprising socket 10 provided as a vehicle unit and plug 20 that will self-align during mating while allowing for sufficient parking misalignment. The plug 20 is mounted to a ground unit (see FIGS. 3A-B) comprising a mover 30 also referred to as a handler, a manipulator, a robot or an off-board robot handler, advantageously through a hinge point (e.g. a spherical joint such as ball joint 31) providing the required (passive) degrees of freedom.

The mating direction of the plug and socket of the vehicle coupler assembly is advantageously in the horizontal plane (e.g. parallel to the x,y plane). The force required for mating is delivered by a (short) linear movement of at least one of the engaging members 11, 14 of the vehicle socket 10. Therefore, the off-board robot handler 30 can be limited to a low force handler (about 5N and less than 200N). Because of the low force design the handler 30 will be fully backdrivable. This fully backdrivable robot handler 30 does not require additional provisions to provide compliance when the car moves after mating.

The plug 20 itself comprises contra-connectors 21, potentially comprising three phase power contacts, a neutral potential contact, a protective earth contact and 2 communication contacts 25 (similar to the standard type 2 plug) and a plastic housing.

It advantageously does not contain any moving parts or springs. This greatly improves the reliability and simplicity of the plug.

Referring to FIG. 1, the vehicle coupler assembly can comprise one or a combination of the following elements:
Plug 20 providing a connection device attached to a tip of an off-board robot handler 30, comprising electrical contra-connectors 21 arranged for engaging electrical connectors (not shown) provided in the socket 10.
First vehicle socket engaging member 11 forming a receptacle for the plug 20 provided in socket 10 and comprising connectors, which are electrically connected to the onboard charger.
Landing plane 13 providing an abutting surface 16 as a physical limiter. This feature in the socket is capable of accepting the plug with an offset in the XY plane and forms the reference for parallel alignment of the first surface 23 of the plug with the abutting surface 16, e.g. providing a horizontal alignment.
Second vehicle socket engaging member 14 providing a catch plate, which is a feature in the vehicle unit that advantageously co-operates with the first vehicle socket engaging member 11. Either one or both are shaped with a geometry 15 to align the plug 20 with the vehicle socket 10 in a horizontal plane (rotation and offset).
Alignment features/ribs 12, 22 may be provided on the plug 20 as extending fins 22, preferably provided on the outer contra-connectors, and the first vehicle socket engaging member 11 as a protruding edge. These geometrical features are configured to co-operate. Together these geometrical features make sure the electrical contra-connector pins 21 will align with the connectors provided in the socket before mating, such as when the first engaging member 11 abuts the plug 20 and moves towards the second engaging member 14.
Cavity 17 for receiving the plug which may be provided by the two engaging members 11, 14 and the landing plane 13.
Covers (not shown) for covering socket and/or plug during idle time.

Alignment principle by orienting and centering the plug 20 along the three axes:

Plug 20 is pushed by handler 30 against the landing plane 13 of the socket inside the bottom plate of the vehicle so that the plug abuts against the abutting surface. This orients the plug in the correct x,y plane. The first vehicle socket engaging member 11 moves in −X towards second engaging member 14 and pushes the plug 20 against a catch plate 15. The alignment features 12, 22 co-operate to orient the plug in the correct x,z plane such that the connectors and contra-connectors are correctly oriented for mating. The centring geometries 15, 24 co-operate for centering the plug by translation along the y axis such that the connectors and contra-connectors are correctly aligned for mating.

The plug 20 advantageously comprises alignment features/ribs 22 to make sure the plug is rotated to the correct orientation to allow for mating.

The catch plate and plug advantageously comprise complementary rounded geometries (e.g. convex, concave) to make sure that misalignment in XY and possibly orientation is corrected for when the vehicle socket is pushed to the plug. An alternative can be a triangular shape which exhibits similar behavior.

The lock between the vehicle unit 10 and the ground unit 20, 30 can be realized by means of features integrated in the socket and the plug.

The plug and the socket comprise one or more electrical connectors, such as pins 21 provided on the plug providing female contra-connectors and complementary male connectors (not shown) provided on the socket. These electrical connectors can be placed next to each other in the horizontal plane to reduce the height of the module for easier fitting in an electric vehicle.

The landing plane 13 is advantageously larger than the plug 20 to allow for misalignments in all directions.

The mating procedure can comprise one or a combination of the following steps, preferably in the following order (see FIGS. 2A-D):
1. Car is parked above a ground unit comprising an off-board robot 30, preferably inside the parking range, e.g. using short range positioning as a car guidance system;
2. vehicle unit cover opens;
3. Ground unit cover opens (e.g. FIG. 2A);
4. Ground unit handler 30 moves the plug 20 along the z-axis inside the vehicle unit landing pad/cavity 17 (e.g. FIG. 2B);
5. Vehicle unit detects the plug on the landing pad confirmation that the plug is present on the landing;
6. Ground unit provides small holding force along the z-axis and releases all other axes;
7. First vehicle unit engaging member 11 starts moving along the x-axis providing orientation, centering and mating (e.g. FIG. 2C);
8. Mating is completed, e.g. confirmed by a pilot pin (e.g. FIG. 2D);
9. Ground unit releases the z-axis providing compliance in 6 DOFs;
10. Charging starts.
11. Charging stops (e.g. when battery is full)
12. Vehicle units open
13. Plug is ejected from socket by an ejecting mechanism 18 (described further)
14. Plug is retracted by the ground unit handler
15. Vehicle unit closes
16. Ground unit closes

Referring to FIGS. 4A-C and 5A-C, several states of a socket 10 according to an embodiment of the present disclosure are shown. FIGS. 4A and 5A show a socket 10 in a closed state, wherein the first engaging member 11 and second engaging member 14 are in their most proximal position, configured for shielding parts of the socket 10 from fouling, debris or moisture. In the closed state the two engaging members 11, 14 may abut one another and for instance the second engaging member 14 provides a lid for the first engaging member 11, for instance for shielding electrical components and connectors housed in the first engaging member 11. The second engaging member 14 providing the lid may be slidably arranged on at least one or preferably two linear guides, driven by linear driving means 19 and configured for moving relative to the first engaging member 11 along a third direction.

FIGS. 4B and 5B show a socket 10 in a first (open) state configured for receiving a plug 20. In the open state, the second engaging member 14 providing the lid is a positioned at a distance from the first engaging member 11 along the third direction such that a cavity 17 is formed for receiving the plug 20. The lid 14 can be displaced between the closed and open state using a linear driving means 19. In the event that lid 14 comprises a surface 15 arranged for aligning the plug 20 the driving means 19 can also be used for aligning the plug with the socket 10 when the engagement members 11, 14 approach one another and geometry 15 abuts a reciprocal surface 24 of the plug 20.

FIGS. 4C and 5C show a socket 10 in a second (blocking) state wherein a plug 20 is electrically coupled to the socket 10. In this blocking state, an electrical contra-connector on a surface of the plug 20 opposite to surface 24 is mated with a connector of the first engaging member 11. Surface 15 of the second engaging member 14 in this state may abut surface 24 of the plug 20. During the mating procedure ejecting means 18 (e.g. spring loaded pins) may be displaced by the plug into the first engaging member 11. After charging the ejecting means may be used for ejecting the plug by pushing the plug 20 away from the first engaging member 11. Such ejecting means may also be displaced by the second engaging member 14, for instance by surface 15 (see FIGS. 4A and 5A) which may fit into recess of the first engaging member 11.

1. A socket for an automatic coupler assembly for charging electric vehicles, wherein the socket is arranged for receiving a plug along a first direction, the socket comprising:
a limiter configured to limit movement of the plug in the first direction; and
a gripper configured to block movement of the plug in a second direction opposite to the first direction.

2. The socket according to claim 1, wherein at least a directional component of the first direction is upward.

3. The socket according to claim 1, wherein the limiter is configured to at least in part provide a first alignment of the plug and socket for mating.

4. The socket according to claim 3, wherein the first alignment comprises a first translational alignment along a first axis of translation (Z) substantially parallel to the first direction and a first rotational alignment about a first axis of rotation (X) substantially orthogonal to the first direction.

5. The socket according to claim 1, wherein the limiter is a physical limiter providing an abutting surface.

6. (canceled)

7. The socket according to claim 1, wherein the gripper is configured to at least in part provide a second alignment of the plug and socket for mating, wherein the second alignment comprises a second rotational alignment about a third axis of rotation (Z) parallel to the first direction and a second translational alignment along a second axis of translation (X) substantially orthogonal to the first direction.

8. (canceled)

9. The socket according to claim 1, wherein the gripper is configured to engage the plug, the gripper comprising two engaging members moveable relative to one another in a third direction having at least a directional component perpendicular to the first direction.

10. The socket according to claim 9, wherein the at least one of the two engaging members is configured to align a plug for mating with the socket.

11. The socket according to claim 9, wherein at least one of the two engaging members comprises at least one electrical connector.

12. The socket according to claim 9, wherein at least one of the two engaging members is arranged for retaining the plug by blocking the movement of the plug in the second direction.

13. (canceled)

14. The socket according to claim 9, having a first state wherein the two engaging members define a cavity for configured to receive the plug, when the two engaging members are at a distant location with respect to one another, and a second state for blocking movement of the plug in the second direction, when the two engaging members are at a proximal location with respect to one another.

15. The socket according to claim 14, wherein in the second state the two engaging members are configured to abut opposing surfaces of the plug.

16. The socket according to claim 9, wherein a surface of a first one of the two engaging members facing a second one of the two engaging members comprises a first geometry configured to complement a second geometry of a reciprocal surface of the plug.

17. The socket according to claim 16, wherein the first geometry comprises at least one of a protuberance and a depression towards the second one of the two engaging members for aligning the plug.

18-21. (canceled)

22. The socket according to claim 9, wherein the gripper further comprises an ejecting means configured to eject the plug from the socket.

23. The socket according to claim 22, wherein the ejecting means are configured to eject the plug along the third direction.

24. An automatic coupler assembly, comprising:
claim 1; and
a plug, wherein the plug comprises a second surface comprising a first geometry for complementing a second geometry of a reciprocal surface of the socket configured for aligning the plug and the socket for mating.

25. The automatic coupler assembly according to claim 24, wherein the plug comprises a first surface configured to provide a first alignment of the plug and the socket for mating, wherein the first alignment comprises a first translational alignment along a first axis of translation substantially parallel to the first direction and a first rotational alignment about a first axis of rotation substantially orthogonal to the first direction.

26-27. (canceled)

28. The automatic coupler assembly according to claim 24, further comprising a charging station, wherein the charging station comprises the plug, a mover, and a hinging member, wherein the hinging member is configured to connect the plug to the mover and configured to offer degrees of freedom for aligning the plug, wherein the mover is configured to move the plug between a first position more distant from the socket than a second position.

29. A vehicle comprising the socket of claim 1, wherein the socket is arranged on an underside of the vehicle.

30-35. (canceled)
